(19) United States
(12) Patent Application Publication
(10) Pub. No.: US 2004/0130696 A1
(43) Pub. Date: Jul. 8, 2004

(54) Method and apparatus for reducing focal-plane deviation in lithography

(75) Inventor: Ted Doros, Sunnyvale, CA (US)

Correspondence Address: FISH & RICHARDSON, PC, 12390 EL CAMINO REAL, SAN DIEGO, CA, 92130-2081, US

(73) Assignee: Intel Corporation

(21) Appl. No.: 10/338,795

(22) Filed: Jan. 7, 2003

(51) Int. Cl. G03B 27/58

(52) U.S. Cl. 355/72; 355/73; 355/75; 355/53; 310/10; 378/34

(57) ABSTRACT

A wafer chuck may have an engagement surface having a curvature approximating a field curvature of an imaging system in which the wafer chuck is used. The wafer chuck may include an integrated vacuum system operative to secure a wafer to the engagement surface, consequently deforming the wafer to have a surface approximating the field curvature of the imaging system.

### BACKGROUND

The process flow for semiconductor manufacturing may include “front-end” processing, including wafer fabrication, and “back-end” processing, which may include testing, assembly, and packaging. During wafer fabrication, different layers of material may be formed on the wafer using, e.g., photolithography, etching, stripping, diffusion, ion implantation, deposition, and chemical mechanical planarization processes.

A wafer chuck may be used to secure a semiconductor wafer in various stages of wafer fabrication. The wafer chuck may include an integrated vacuum system. The top surface of the wafer chuck may include a number of vacuum lines through which a vacuum may be pulled underneath the wafer. The vacuum lines may be separated by lands which are machined extremely flat in order to hold the wafer flat during a photolithography stage of wafer fabrication. In many lithography imaging systems, the top surface of the wafer may be kept flat as possible in an attempt to minimize focal-plane deviation at the wafer surface.

### BRIEF DESCRIPTION OF THE DRAWINGS

FIG. 1 is a sectional view of a wafer on a wafer chuck with a top surface having a curvature.

FIG. 2 is a sectional view of an image plane having a field curvature.

FIG. 3 illustrates a surface with a radius of curvature.

FIG. 4 is a sectional view of the wafer secured to a top surface the wafer chuck of FIG. 1.

FIG. 5 is a flowchart describing a wafer fabrication operation utilizing the wafer chuck with a top surface having a curvature.

### DETAILED DESCRIPTION

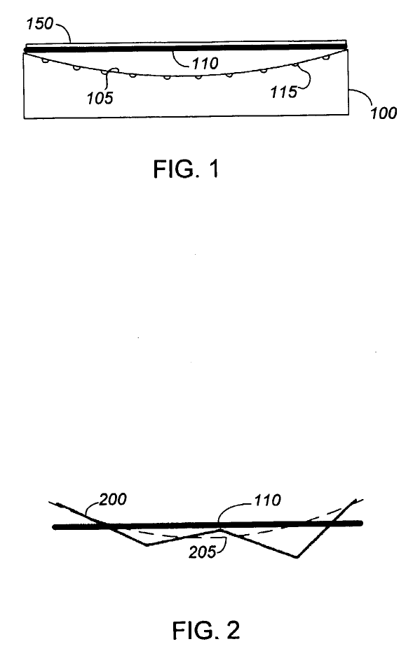

FIG. 1 shows a wafer chuck 100 with a curved top, or “engagement,” surface 105. The wafer chuck may be used to secure a semiconductor wafer 110 during a lithography operation during wafer fabrication. The wafer chuck 100 may include an integrated vacuum system to generate a vacuum which may be used to engage the wafer 110. For example, the engagement surface 105 may include vacuum lines (or holes) 115 through which a vacuum is pulled underneath the wafer.

During a lithography imaging operation, light directed onto a patterned mask (or “reticle”) may be projected onto a layer of a photosensitive resist material (or “photoresist”) 150 on the top surface of the wafer 110. The photoresist layer may be developed and then etched to remove material from the areas exposed with the mask image.

Lithography imaging systems, in particular step-and-repeat (or “stepper”) systems and step-and-scan systems, may be designed to produce a flat aerial image plane 200, or focus-plane, near the wafer surface. This aerial image plane 200 may be thought of as including an infinite number of focused points residing in some common plane. However, in practice, a perfectly flat image plane may be unattainable. Although the deviation from an ideal plane may come in a variety of forms, field curvature (or curvature of field) is a common characteristic approximation.

Field curvature may be common in projection systems. Field curvature may result from using lenses (or other types of focusing elements) with curved surfaces. When light is focused through a curved lens, the image plane produced by the lens may be curved. In lithography, an effect of field curvature is that the image plane generated from a flat mask may be curved, which may produce distortions in the imaged pattern on the flat photoresist layer 150 on the wafer 110 surface.

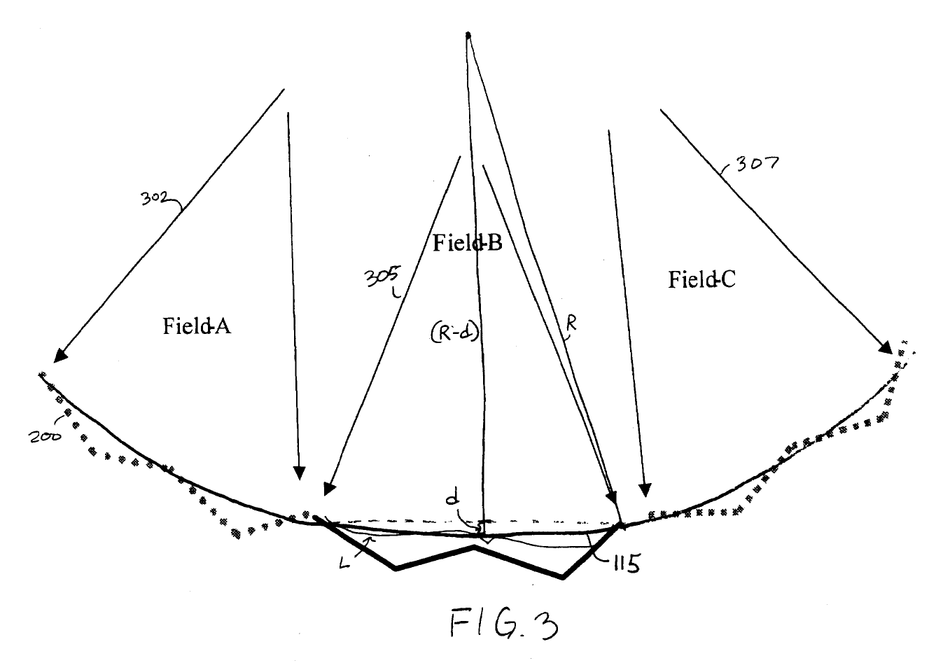

FIG. 2 illustrates an aerial image plane 200 with exaggerated focal-plane deviations superimposed on the wafer 110 in an undeformed, flat state. The focal-plane deviation may include a field curvature 205. The field curvature 205 may be obtained by, e.g., taking a (weighted) average distance from the mask of focal points on the focal plane and/or determining a best fit field curvature from a set group of field curvatures.

The wafer chuck 100 may mitigate loss of imaging performance due to aerial image plane 200 field curvature by deforming the wafer 110 surface on which the mask image is to be focused. The radius of curvature (R) of the wafer chuck may be equivalent to or approximate a radius of a hypothetical circle which fits the curvature of the engagement surface 115, as shown in FIG. 3. The radius of curvature may be determined from the maximum deviation (d) and the length (L) of the field over which the curvature is measured using the following equation:

$$R = \frac{4 {d}^{2} + {L}^{2}}{8 d}$$

The engagement surface 105 of the wafer chuck 100 may have a curvature which approximates the field curvature 205 of the aerial image plane 200. The curvature of the engagement surface 105 may be determined over a local imaging field (or “exposure field”). For example, FIG. 3 shows three fields: Field-A 302; Field-B 305; and Field-C 307. The curvature may be measured over Field-B 305. This curvature may be extended across the entire engagement surface 105, including Field-A 302 and Field-C 307, such that the surface has a constant curvature.

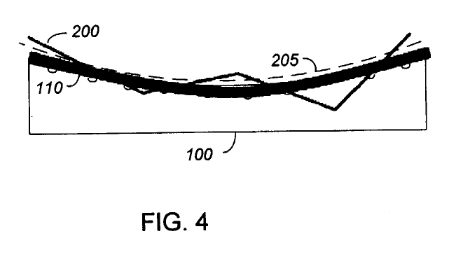

The strength of the vacuum may be sufficient to deform the wafer 110 such that the curvature of the top surface of the wafer 110 substantially matches the curvature of the engagement surface 105, as shown in FIG. 4. The wafer 110 may be deformed as it engages the wafer chuck 100 under vacuum. The top surface of the wafer 110 may be deformed to approximate the curvature of the engagement surface 105, and hence, the field curvature 205 of the aerial image field 200. By maintaining a constant curvature across the wafer chuck 100, any location on the wafer 110 may exhibit a similar curvature and therefore a similar imaging complement.

The curvature of the engagement surface 105 on the wafer chuck 100 may be designed based on the field curvature of the aerial image plane 200 of a particular system. For example, consider an imaging system having a field curvature of 240 nm field across a 20 mm field (R˜208 m). A complementary wafer chuck designed with a matching curvature of 240 nm across a 20 mm field within a tolerance of, e.g., +/−10 nm may be used with this imaging system.

Alternatively, a “best fit” approach may be used to match wafer chucks to imaging systems. Chucks and imaging systems may be classified based on a range of curvatures. For example, imaging systems with a positive curvature of less 100 nm across a 20 mm field (R˜500 m) may be placed in a Class “A” category. The Class A system may be matched with a wafer chuck 100 from a Class “A” category which includes wafer chucks with engagement surfaces having a curvature greater than about 50 nm (R˜1000 m) but less than 100 nm (R˜500 m) across a 20 mm field. Other categories may include imaging systems and wafer chucks with different degrees of curvature. For example, a Class “B” category may include systems and chucks having curvatures between 100 nm (R˜500 m) and 200 nm (R˜250 m) across a 20 mm field, and a Class “C” category may include systems and chucks having curvatures between 200 nm (R˜250 m) and 300 nm (R˜167 m) across a 20 mm field.

The degree of curvature of the engagement surface 105 may fall within normal variations seen in wafer surface irregularities as well as typical lot-to-lot and wafer-to-wafer thickness variations.

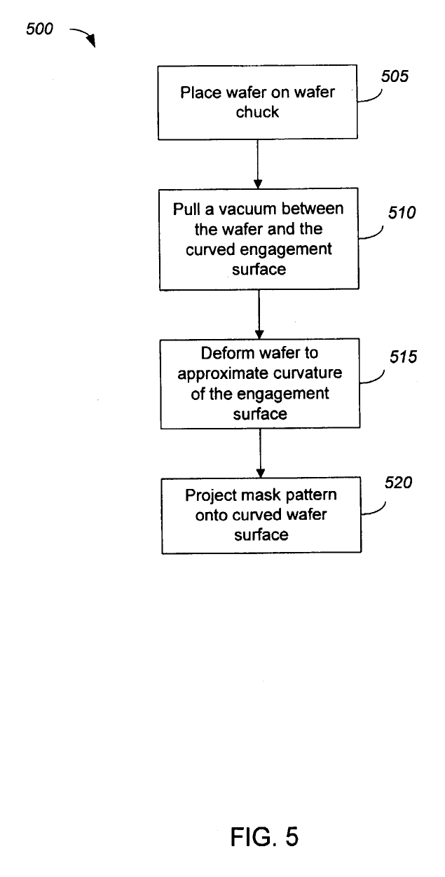

FIG. 5 shows a flowchart describing a wafer 110 fabrication operation 500 using a wafer chuck 100. A wafer 110 may be placed on the wafer chuck 100 (block 505). The wafer 110 may be secured to the wafer chuck 100 by pulling a vacuum between the wafer 110 and the curved engagement surface 105 (block 510). The wafer 110 may be deformed as it is secured to the wafer chuck 100 such that the curvature of the wafer 110 surface approximates a field curvature of the aerial image plane 200 (block 515). The mask pattern may then be projected onto the photoresist on the curved wafer 110 surface (block 520).

The wafer chuck 100 may be used in different types of lithography imaging systems, including, e.g., step-and-repeat systems and step-and-scan systems. In a step-and-repeat system, small blocks of dies may be exposed simultaneously. In a step-and-scan system, small blocks of dies may be exposed in scans across the reticle. For a step-and-repeat system, the curvature of the engagement surface 105 may be controlled in three dimensions, e.g., the surface may correspond to a portion of the surface of a sphere. For a step-and-scan system, the curvature of the engagement surface 105 may be controlled in two dimensions, e.g., the surface may correspond to a portion of the surface of a cylinder.

Different lithography imaging systems may use different wavelengths of light, such as ultraviolet (“UV”), deep UV (“DUV”), or extreme UV (“EUV”). For example, an EUV lithography (EUVL) system may use wavelengths between about 10 nm and 14 nm, which may also be referred to as “soft” x-rays. The curved wafer chuck 100 may be used in such lithography imaging systems.

A number of embodiments have been described. Nevertheless, it will be understood that various modifications may be made without departing from the spirit and scope of the invention. For example, block in the flowchart may be skipped or performed out of order and still produce desirable results. Accordingly, other embodiments are within the scope of the following claims.

1. Apparatus comprising:
a surface adapted to engage a wafer, said surface having a radius of curvature approximating a field curvature of an imaging system.

2. The apparatus of claim 1, wherein the surface has a constant curvature.

3. The apparatus of claim 1, wherein the radius of curvature is greater than about 1000 m.

4. The apparatus of claim 3, wherein the radius of curvature is less than about 167 m.

5. The apparatus of claim 1, wherein the radius of curvature is greater than 500 m.

6. The apparatus of claim 1, wherein the curvature is greater than about 250 m.

7. The apparatus of claim 1, wherein the radius of curvature is greater than about 167 m.

8. The apparatus of claim 1, wherein the curvature is in two dimensions.

9. The apparatus of claim 1, wherein the curvature is in three dimensions.

10. The apparatus of claim 1, wherein the wafer has a substantially flat wafer surface prior to engagement with the surface.

11. The apparatus of claim 1, wherein the surface includes a plurality of apertures operative to pull a vacuum between the surface and the wafer.

12. A method comprising:
deforming a wafer having a surface to produce a radius of curvature on the surface approximating a field curvature of an imaging system.

13. The method of claim 12, wherein said deforming comprises pulling a vacuum between the wafer and a curved engagement surface.

14. The method of claim 12, wherein said deforming comprises deforming the surface to produce a radius of curvature on the surface of greater than about 1000 m.

15. The method of claim 14, wherein said deforming comprises deforming the surface to produce a radius of curvature on the surface of less about 167 m.

16. The method of claim 12, wherein said deforming comprises deforming the surface to produce a radius of curvature on the surface of greater than about 500 m.

17. The method of claim 12, wherein said deforming comprises deforming the surface to produce a radius of curvature on the surface of greater than about 250 m.

18. The method of claim 12, wherein said deforming comprises deforming the surface to produce a constant curvature on the surface.

19. The method of claim 12, further comprising:
imaging a mask pattern on the surface of the wafer.

20. A system comprising:
an imaging system having a field curvature; and
a chuck having a surface adapted to engage a wafer, said surface having a curvature approximating a field curvature of the imaging system.

21. The system of claim 20, wherein the surface has a constant curvature.

22. The system of claim 20, wherein the radius of curvature of the surface is greater than about 1000 m.

23. The system of claim 20, further comprising:
a vacuum system operative to pull a vacuum between the surface and a wafer.

24. The system of claim 20, wherein the imaging system comprises an extreme ultraviolet lithography (EUVL) imaging system.
